(19) United States
(12) Patent Application Publication
(10) Pub. No.: US 2002/0099107 A1
(43) Pub. Date: Jul. 25, 2002

(54) Textile fibers made from strengthened polypropylene

(76) Inventors: John David Tucker, Roswell, GA (US); Sunggyu Lee, Columbia, MO (US); Bryon P. Day, Canton, GA (US)

Correspondence Address: Pauley Petersen Kinne & Fejer, Suite 365, 2800 W. Higgins Road, Hoffman Estates, IL, 60195, US

(21) Appl. No.: 09/967,218

(22) Filed: Sep. 28, 2001

Related U.S. Application Data
(60) Provisional application No. 60/243,656, filed on Oct. 27, 2000.

(51) Int. Cl. C08J 9/28; C08J 9/30

(52) U.S. Cl. 521/71; 525/332.1; 524/426

(57) ABSTRACT

A textile fiber including polypropylene blended with an impact modifier. The impact modifier can be less than 10% by weight of the composition. Examples of suitable impact modifiers include ethylene-propylene-diene-monomer (EPDM), styrene/ethylene-co-butadiene/styrene (SEBS), and styrene-poly(ethylene-propylene)-styrene-poly(ethylene-propylene) (SEPSEP). The textile fiber can be used to form a spunbond fiber, a staple fiber, a multi-fiber yarn, a knit fabric, a woven fabric, or a nonwoven fabric.

### FIELD OF THE INVENTION

This invention is directed to textile fibers including polypropylene and an impact modifier.

### BACKGROUND OF THE INVENTION

Textile fibers include a wide range of fibers that can be integrated into an even wider range of fabrics. For example, textile fibers can include spunbond fibers and staple fibers, and can be integrated into multi-fiber yarns, knits, woven fabrics, and nonwoven fabrics, to name a few. Small fiber size and high tensile strength are desirable properties of textile fibers.

A common problem that arises during the process of making typical polypropylene textile fibers is a phenomena commonly referred to as “roping.” Roping occurs during the process of blending copolymer/polypropylene blends wherein the blends possess melt elasticity. More particularly, roping refers to fiber breakage below the pack snap back toward the pack, thereby entangling additional fibers.

Not only are polypropylene textile fibers difficult to manufacture, the fibers themselves can be difficult to work with. Impact modifiers are typically added to the polypropylene to provide increased toughness and impact strength. However, such impact modifiers typically weaken the tensile strength of the fibers.

There is a need or desire in the textile fiber industry for fibers having high tensile strength. There is also a need or desire for textile fibers that are easy to manufacture.

### SUMMARY OF THE INVENTION

The present invention is directed to textile fibers made from strengthened polypropylene. The polypropylene is strengthened with an impact modifier. Examples of suitable impact modifiers include ethylene-propylene-diene-monomer (EPDM), styrene/ethylene-co-butadiene/styrene (SEBS), and styrene-poly(ethylene-propylene)-styrene-poly(ethylene-propylene) (SEPSEP). These modifiers are effective when present in about 1-10% by weight of the composition. The fibers thus prepared have higher strength and elongation at break compared to polypropylene alone.

The fibers of this invention lack melt elasticity compared to other polypropylene/impact modifier blends, thereby avoiding any “roping” during the manufacturing process. The impact modifier used in this invention creates a plasticizing effect that allows the polypropylene chains to slip more easily. Another attribute of the fibers of this invention is improved fabric softness resulting from the addition of the impact modifier.

With the foregoing in mind, it is a feature and advantage of the invention to provide textile fibers having high tensile strength.

It is another feature and advantage of the invention to provide textile fibers that are easy to manufacture.

### BRIEF DESCRIPTION OF THE DRAWINGS

FIG. 1 is an illustration of a mechanical drawing process for making textile fibers including polypropylene and an impact modifier;

FIG. 2 is an illustration of a pneumatic drawing process for making textile fibers including polypropylene and an impact modifier;

FIG. 3 is an illustration of an air-quenched, direct threaded configuration of the process of the invention;

FIG. 4 is an illustration of an air-quenched, threaded wind-up configuration of the process of the invention;

FIG. 5 is an illustration of a water-quenched, direct threaded configuration of the process of the invention; and

FIG. 6 is an illustration of a water-quenched, threaded wind-up configuration of the process of the invention.

### DEFINITIONS

Within the context of this specification, each term or phrase below will include the following meaning or meanings.

“Elastomeric” refers to a material or composite which can be elongated by at least 50 percent of its relaxed length and which will recover, upon release of the applied force, at least 40 percent of its elongation. It is generally preferred that the elastomeric material or composite be capable of being elongated by at least 100 percent, more preferably by at least 300 percent, of its relaxed length and recover, upon release of an applied force, at least 50 percent of its elongation.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Spunbonded fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. NO. 3,502,763 to Hartmann, U.S. Pat. NO. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6and 10.

“Thermoplastic” describes a material that softens when exposed to heat and which substantially returns to a nonsoftened condition when cooled to room temperature.

These terms may be defined with additional language in the remaining portions of the specification.

### DETAILED DESCRIPTION OF THE PRESENTLY PREFERRED EMBODIMENTS

The textile fibers of the invention include strengthened polypropylene. “Polypropylene” refers to propylene homopolymers as well as copolymers containing up to about 10% by weight ethylene or a C₄-C₂₀ alpha-olefin comonomer. The polypropylene is strengthened by the addition of an impact modifier. The impact modifier constitutes about 1-25% by weight of the composite fibers, suitably about 2-15% by weight of the composite fibers, more suitably about 3-10% by weight of the composite fibers.

As used herein, the term “impact modifier” refers to a synthetic material having elastomeric properties. The impact modifier is partially compatible with polypropylene. More particularly, the impact modifier disperses extremely well in propylene without dissolving. Examples of suitable impact modifiers include ethylene-propylene-diene-monomer (EPDM), styrene/ethylene-co-butadiene/styrene (SEBS), and styrene-poly(ethylene-propylene)-styrene-poly(ethylene-propylene) (SEPSEP). Other examples include diblock, triblock, tetrablock or other multi-block elastomeric copolymers such as olefinic copolymers, including styrene-isoprene-styrene, styrene-butadiene-styrene, or styrene-ethylene/propylene-styrene, which may be obtained from the Shell Chemical Company, under the trade designation KRATON® elastomeric resin; polyurethanes, including those available from E. I. Du Pont de Nemours Co., under the trade name LYCRA® polyurethane; polyamides, including polyether block amides available from Ato Chemical Company, under the trade name PEBAX® polyether block amide; polyesters, such as those available from E. I. Du Pont de Nemours Co., under the trade name HYTREL® polyester; single-site or metallocene-catalyzed polyolefins having density less than about 0.89 grams/cc, available from Dow Chemical Co. under the trade name AFFINITY®; and ethylene/styrene also available from Dow Chemical Co.

A number of block copolymers can be used to prepare the impact modifiers useful in this invention. Such block copolymers generally comprise an elastomeric midblock portion B and a thermoplastic endblock portion A. The block copolymers may also be thermoplastic in the sense that they can be melted, formed, and resolidified several times with little or no change in physical properties (assuming a minimum of oxidative degradation).

Endblock portion A may comprise a poly(vinylarene), such as polystyrene. Midblock portion B may comprise a substantially amorphous polyolefin such as polyisoprene, ethylene/propylene polymers, ethylene/butylene polymers, polybutadiene, and the like, or mixtures thereof.

Suitable block copolymers useful in this invention include at least two substantially polystyrene endblock portions and at least one substantially ethylene/butylene mid-block portion. Commercially available examples of such a linear block copolymer includes the SEBS block copolymer, available from the Shell Chemical Company, under the trade designations KRATON® G1657, G1652, and G2760 elastomeric resins. Typical properties of KRATON® G1657 elastomeric resin are reported to include a tensile strength of 3400 pounds per square inch (2×10⁶ kilograms per square meter), a 300 percent modulus of 350 pounds per square inch (1.4×10⁵ kilograms per square meter), an elongation of 750 percent at break, a Shore A hardness of 65, and a Brookfield viscosity, when at a concentration of 25 weight percent in a toluene solution, of about 4200 centipoise at room temperature. Another suitable elastomer, KRATON® G2746, is a styrene butadiene block copolymer blended with tackifier and low density polyethylene.

The polypropylene may be blended with the impact modifier using any suitable process, including processes presently used for forming polypropylene fibers. For instance, U.S. Pat. No. 5,534,335, issued to Everhart, et al., the disclosure of which is incorporated herein by reference, describes a process for making fibers from thermoplastic polymers, such as polypropylene. In that process, the fibers are produced by meltblowing or spunbonding processes which are well known in the art. These processes generally use an extruder to supply melted polymer to a spinnerette, or meltblowing die, where the polymer is fiberized. The fibers can then be drawn, usually pneumatically, and deposited on a foraminous mat or belt to form a nonwoven fabric, for example. Fibers produced in the spunbond and meltblown processes are generally in the range of from about 1 to about 50 microns in diameter, depending on process conditions and the desired end use for the fabrics to be produced from such fibers.

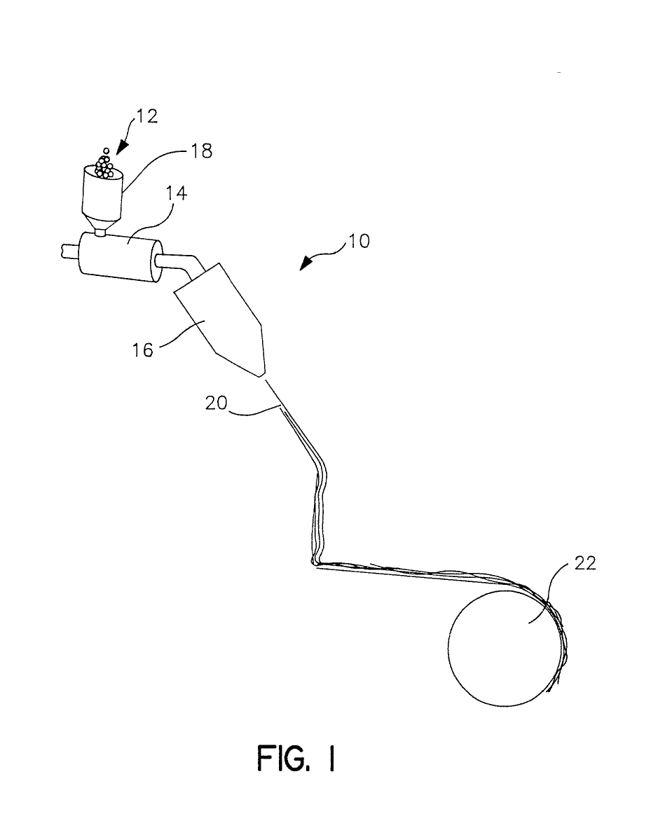

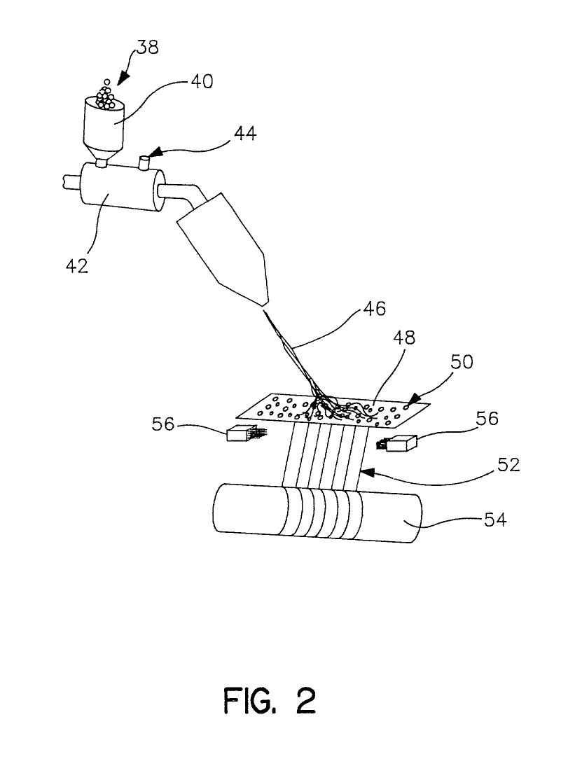

Referring to FIGS. 1 and 2, an exemplary apparatus for forming textile fibers with strengthened polypropylene is generally represented by reference numeral 10. In forming the fibers of the present invention, the fibers can be drawn either mechanically (FIG. 1) or pneumatically (FIG. 2). The pneumatic drawing method is explained below.

First of all, in the mechanical drawing method illustrated in FIG. 1, polymer pellets 12 are accurately weighed and dry-mixed, thereby ensuring that a homogeneous mixture is fed to an extruder 14. The extruder 14 is heated to about 180 degrees Celsius, and when all zones within the extruder 14 reach about 180 degrees Celsius, a 10-minute soak time is observed to insure that all polymer contained within the extruder 14 and die 16 from a previous run is completely melted. The extruder 14 is then purged with polypropylene at about 32 RPM to remove any polymer remaining from the previous run. Prior to feeding the dry-mixed blend, tracer pellets are fed into the extruder 14. The dry-blended polymers are compounded immediately following the tracer pellets. When the color of the tracer appears and fades from the extrudate 20, additional tracer pellets are fed. When the second addition of tracer has faded, it is presumed that the extrudate 20 is the desired composition. During compounding, the RPM of the extruder 14 is maintained at about 32 RPM. In cases where gravimetric feed is used, a feed hopper 18 is maintained with sufficient polymer such that a constant feed rate is maintained, as determined by the size of the materials fed.

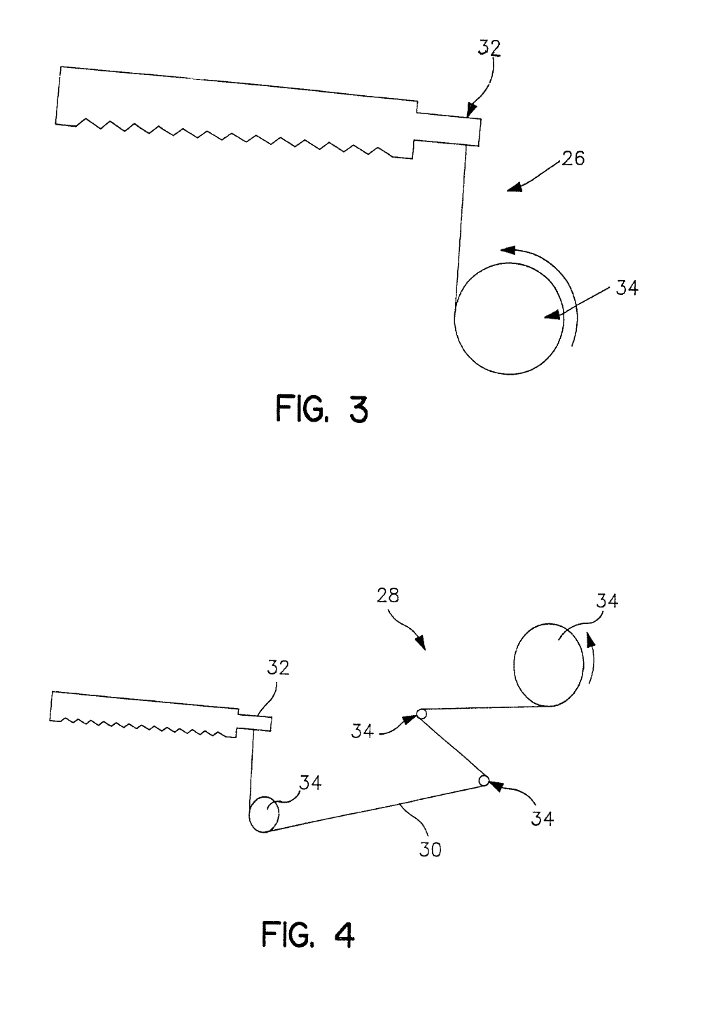

Once the polymer pellets are blended, the fibers are then produced. First, the motor speed is adjusted to about 5 RPM. Then, the extrudate 20 is quenched and threaded according to the desired configuration, and attached to a wind-up roll 22. At this point, the extruder 14 is shut off and the fibers are drawn from the die 16 continuously. In order to produce fibers of the desired size, fibers are cut from the roll 22 and measured using a microscope equipped with an eyepiece reticle. Adjustments in take-off speed are made to produce the desired size fibers empirically. Once the correct speed is determined, fibers can be produced in two-minute intervals. Between intervals, the extruder 14 is operated at about 32 RPM for a period of about two minutes to insure that fibers produced do not have significant phase separation as a function of collection time. Four processing conditions can be employed to impart varying properties in the fibers, including combinations of two quenching and two threading conditions. Schematics of these four processing conditions are given in FIGS. 3-6.

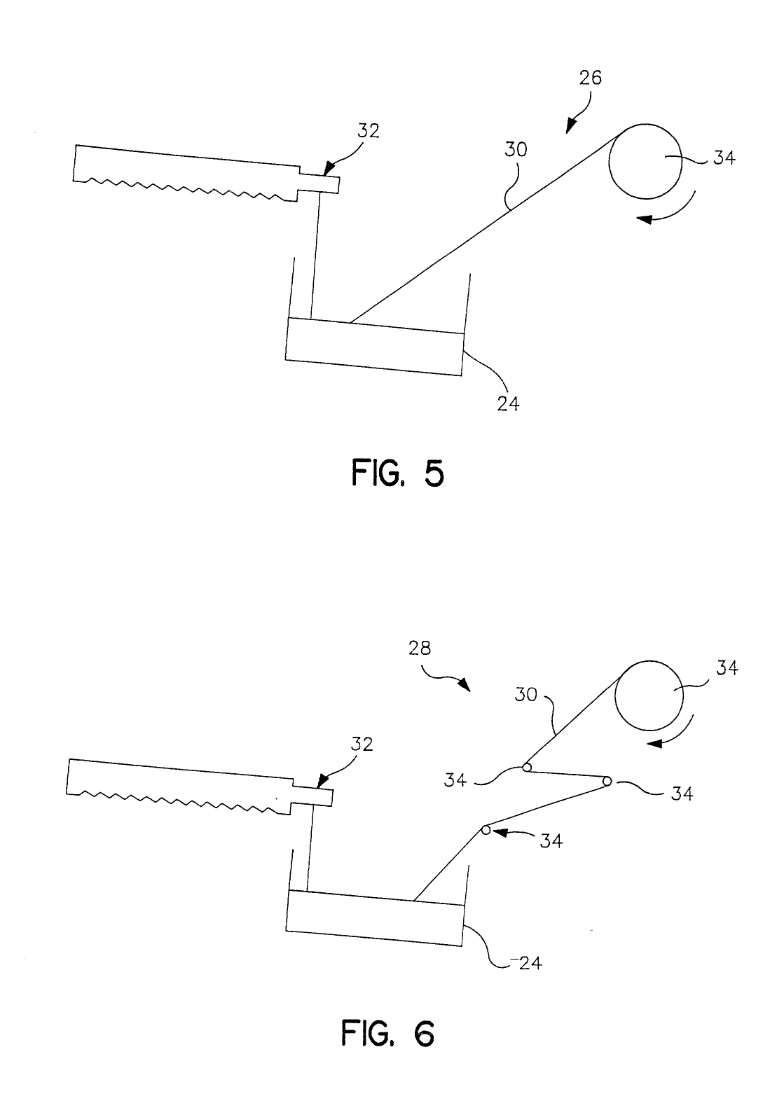

Two types of quenching are employed in this work, namely air-quenching (FIGS. 3 and 4) and water-quenching (FIGS. 5 and 6). Air-quenching is a process where the fibers 30 are quenched in air without the aid of any fluid stream. The fibers 30 are quenched in ambient air. Water quenching is achieved by threading the fiber 30 through a water bath 24. The process of water quenching provides a much faster quench than air due to the greater thermal energy flux present.

Two types of threading conditions are employed in this work, namely a direct threaded system 26 (FIGS. 3 and 5) and a threaded wind-up system 28 (FIGS. 4 and 6). In the direct threaded system 26, fibers 30 are drawn from the extruder die 32, through whichever quenching medium is used, and wound directly around the wind-up roll 34, which provides the RPM necessary to maintain the desired fiber diameter. In the threaded wind-up system 28, the fiber 30 is once again drawn from the extruder die 32 through the quenching medium. At this point the fiber 30 is threaded around several support rolls 36 in a take-off unit before being wound on the wind-up roll 34.

In the pneumatic drawing method, illustrated in FIG. 2, the materials 38 to be blended are dry-mixed at the desired ratio. These materials 38 are added to a feed hopper 40 with variable feed rate control, maintained at about 20 lb/hr. A co-rotating 27 mm twin screw extruder with a length/diameter ratio of 40:1 at 200 RPM is an example of a suitable extruder 42 that can be used, with a flat temperature profile at about 210 degrees Celsius. A venting port 44 can be used to remove volatile gases.

Following compounding, the melt blended materials 46 are transported to a plate 48 with multiple orifices 50 through which fibers 52 are drawn. The plate 48 or “spin pack” and surrounding materials are maintained at desired temperatures ranging between about 210 and 250 degrees Celsius. One example of a suitable spin pack includes a spin pack having 310 holes at a density of 50 holes/inch². The holes are suitably about 0.6 inches in diameter and have a length/diameter ratio of about 6:1. The fibers 52 can be drawn using high velocity air at pressures ranging from 2-20 psi using a Fiber Drawing Unit (FDU) 54. Between the spin pack 48 and FDU 54, a length of about 48 inches can exist. In the upper portions of the spin length, quench boxes 56 can be used to cool the polymer more rapidly at velocity rates between 0 and 280 ft/min.

As a result of combining the impact modifier with the polypropylene, the textile fibers have improved fabric softness, increased strength, and/or elongation at break at identical throughput levels compared to polypropylene homopolymer fibers, as shown in the Example below.

### EXAMPLES

Stabilized textile fibers were prepared from Escorene 3155 polypropylene (obtained from Exxon). A second set of stabilized textile fibers was prepared from 3% Buna 2070 EPDM (obtained from Bayer) blended with 97% Escorene 3155 polypropylene. The EPDM and polypropylene were combined and drawn using the preferred process described above with respect to FIG. 1. Both sets of fibers were successfully drawn between 0.4 grams/hole/minute and 0.6 grams/hole/minute at a range of temperature from 230 degrees Celsius to 250 degrees Celsius, although there is no apparent restriction on throughput or temperature for the fibers of the invention. The drawing pressure used in the fiber drawing unit allowed fibers to be drawn at pressures up to and above 15 psi. Other specifics include the use of a 310 hole pack at 128 holes/inch with hole diameters of 0.6 mm. Both of the sets of fibers were tested for tensile strength, elongation at break, and diameter under varying temperatures, draw pressures, and quenching conditions. The data extracted from these tests are shown in Table 1 below.

TABLE 1
Polypropylene Fibers Versus Polypropylene Fibers Blended With
EPDM

| | | | Draw | | | Elonga- | |
|---|---|---|---|---|---|---|---|
| | | | Pres- | | Tensile | tion | |
| Sam- | Com- | Temp | sure | | Strength | at Break | Diameter |
| ple | position | (° C.) | (psi) | Quench | (Mpa) | (%) | (microns) |
| 1a | 100% PP | 230 | 8 | Off | 135.38 | 212.79 | 20.51 |
| 1b | 100% PP | 230 | 8 | 0.4 in | 128.34 | 289.80 | 25.71 |
| | | | | H₂O | | | |
| 2a | 100% PP | 230 | 15 | Off | 123.86 | 180.80 | 16.85 |
| 2b | 100% PP | 230 | 15 | 0.4 in | 130.65 | 196.10 | 14.93 |
| | | | | H₂O | | | |
| 3a | 100% PP | 250 | 8 | Off | 198.42 | 179.86 | 13.70 |
| 3b | 100% PP | 250 | 8 | 0.4 in | 124.29 | 165.87 | 17.16 |
| | | | | H₂O | | | |
| 4a | 100% PP | 250 | 15 | Off | 192.35 | 146.05 | 12.71 |
| 4b | 100% PP | 250 | 15 | 0.4 in | 237.42 | 109.03 | 11.78 |
| | | | | H₂O | | | |
| 5a | 97% PP/ | 250 | 8 | Off | 159.96 | 209.66 | 15.91 |
| | 3% Buna | | | | | | |
| | 2070 | | | | | | |
| 5b | 97% PP/ | 250 | 8 | 0.4 in | 219.80 | 136.13 | 15.06 |
| | 3% Buna | | | H₂O | | | |
| | 2070 | | | | | | |
| 6a | 97% PP/ | 250 | 15 | Off | 219.54 | 119.39 | 13.94 |
| | 3% Buna | | | | | | |
| | 2070 | | | | | | |
| 6b | 97% PP/ | 250 | 15 | 0.4 in | 274.86 | 143.68 | 11.03 |
| | 3% Buna | | | H₂O | | | |
| | 2070 | | | | | | |
| 7a | 97% PP/ | 230 | 8 | Off | 221.30 | 181.17 | 13.24 |
| | 3% Buna | | | | | | |
| | 2070 | | | | | | |
| 7b | 97% PP/ | 230 | 8 | 0.4 in | 132.79 | 288.16 | 18.58 |
| | 3% Buna | | | H₂O | | | |
| | 2070 | | | | | | |
| 8a | 97% PP/ | 230 | 15 | Off | 141.08 | 220.36 | 19.66 |
| | 3% Buna | | | | | | |
| | 2070 | | | | | | |
| 8b | 97% PP/ | 230 | 15 | 0.4 in | 140.95 | 152.08 | 18.39 |
| | 3% Buna | | | H₂O | | | |
| | 2070 | | | | | | |

As can be seen in Table 1, the composite EPDM/PP fibers had an average increase in strength of 19% and decrease in size of 6% observed across the entire range of variables tested. Comparisons of individual treatments comparing 3% Buna in polypropylene to polypropylene homopolymer at identical processing conditions show as much as a 63% increase in strength, a 32% increase in elongation at break, and a reduction in size of 35%. In addition, it is possible to simultaneously improve all three responses at certain treatment combinations.

More textile fibers of Escorene 3155 polypropylene and combinations of polypropylene and Buna 2070 EPDM were formed and tested under various conditions, as shown in Table 2. Included in Table 2 is comparison data showing the differences between the polypropylene fibers and the blended fibers. Cup crush load data and cup crush energy data were obtained according to the procedure described below. Drape data was obtained according to the procedure in ASTM D1388. Elmendorf tear data was obtained according to the procedure in ASTM D1424-83. Denier data was obtained by measuring the fiber diameter and calculating cross-sectional area, then using the density of the fiber, the mass in grams/9000 yards of filament was calculated. Trap tear data was obtained according to the procedure in ASTM D1117-14. Grab data was obtained according to the procedure in ASTM D5034-90.

TABLE 2
Polypropylene Fibers Versus Polypropylene Fibers Blended With EPDM

| | 100% PP @ | 99% PP, | | 97% PP, | | 95% PP, | |
|---|---|---|---|---|---|---|---|
| Testing | 285° C. | 1% EPDM | vs. | 3% EPDM | vs. | 5% EPDM | vs. |
| Info | (Control) | @ 285° C. | Control | @ 286° C. | Control | @ 285° C. | Control |
| Basis | ave 0.99 | 0.93 | | 1.02 | | 1.00 | |
| Weight | stdev 0.04 | 0.04 | | 0.02 | | 0.03 | |
| (oz/yard²) | | | | | | | |
| Cup Crush | ave 109.94 | 100.66 | −8% | 82.71 | −25% | 89.21 | −19% |
| Load | stdev 1.69 | 3.20 | | 3.38 | | 3.46 | |
| (g/oz) | | | | | | | |
| Cup Crush | ave 2147.47 | 1954.23 | −9% | 1579.08 | −26% | 1642.65 | −24% |
| Energy | stdev 144.50 | 243.80 | | 107.60 | | 184.11 | |
| (g/mm/oz) | | | | | | | |
| Drape CD | ave 3.00 | 2.92 | −3% | 2.39 | −20% | 2.92 | −3% |
| (cm/oz) | stdev 0.46 | 0.35 | | 0.31 | | 0.32 | |
| Drape MD | ave 3.81 | 4.18 | 10% | 3.63 | −5% | 3.67 | −4% |
| (cm/oz) | stdev 0.35 | 0.78 | | 0.41 | | 0.22 | |
| Elmendorf | ave 732.22 | 839.34 | 15% | 684.28 | −7% | 769.36 | 5% |
| Tear CD | stdev 92.60 | 133.36 | | 95.25 | | 210.80 | |
| (cN/oz) | | | | | | | |
| Elmendorf | ave 802.83 | 840.20 | 5% | 835.84 | 4% | 700.27 | −13% |
| Tear MD | stdev 93.50 | 79.78 | | 205.90 | | 121.40 | |
| (cN/oz) | | | | | | | |
| Size | ave 20.60 | 20.86 | 1% | 21.30 | 3% | 20.55 | 0% |
| (microns) | stdev 0.90 | 1.69 | | 1.94 | | 1.30 | |
| Denier | ave 2.70 | 2.79 | 3% | 2.92 | 8% | 2.70 | 0% |
| | stdev 0.24 | 0.44 | | 0.52 | | 0.35 | |
| Trap Tear | ave 5.60 | 6.68 | 19% | 6.26 | 12% | 6.76 | 21% |
| MD | stdev 0.38 | 0.66 | | 1.06 | | 0.40 | |
| (lb/oz) | | | | | | | |
| Trap Tear | ave 3.83 | 3.65 | −5% | 3.97 | 4% | 4.19 | 9% |
| CD (lb/oz) | stdev 0.45 | 0.45 | | 0.50 | | 0.54 | |
| Grab Load | ave 11.75 | 14.66 | 25% | 12.58 | 7% | 13.83 | 18% |
| MD | stdev 0.76 | 0.98 | | 1.70 | | 0.99 | |
| (lb/oz) | | | | | | | |
| Grab | ave 50.60 | 51.22 | 1% | 62.89 | 24% | 69.66 | 38% |
| Strain MD | stdev 7.13 | 3.71 | | 8.47 | | 6.20 | |
| (%) | | | | | | | |
| Grab | ave 11.24 | 13.47 | 20% | 14.24 | 27% | 17.29 | 54% |
| Energy | stdev 2.14 | 1.42 | | 3.78 | | 2.77 | |
| MD | | | | | | | |
| (in-lb/oz) | | | | | | | |
| Grab Load | ave 9.37 | 9.57 | 2% | 9.56 | 2% | 10.65 | 14% |
| CD (lb/oz) | stdev 0.78 | 1.50 | | 0.88 | | 0.94 | |
| Grab | ave 71.40 | 76.22 | 7% | 84.37 | 18% | 94.94 | 33% |
| Strain CD | stdev 6.17 | 9.81 | | 10.74 | | 9.48 | |
| (%) | | | | | | | |
| Grab | ave 11.87 | 12.87 | 8% | 13.80 | 16% | 17.27 | 45% |
| Energy | stdev 1.69 | 3.20 | | 3.38 | | 3.46 | |
| CD | | | | | | | |
| (in-lb/oz) | | | | | | | |

Each of the four types of textile fibers shown in Table 2 were also tested for tensile strength, according to the procedure in ASTM D3822, in both the cross direction (CD) and the machine direction (MD). Tensile strength at various points of elongation in the CD is shown in Table 3 and tensile strength at the same points of elongation in the MD is shown in Table 4.

TABLE 3
CD Tensile Strength of Polypropylene Fibers and Blended
Polypropylene Fibers As a Function of Elongation (lb/oz)

| EPDM | 1% | 3% | 5% | 10% | 20% | 50% | 100% |
|---|---|---|---|---|---|---|---|
| (%) | Elongation | Elongation | Elongation | Elongation | Elongation | Elongation | Elongation |
| 0.0 | 0.0965 | 0.3446 | 0.7816 | 1.5965 | 3.1959 | 8.0493 | 6.9713 |
| 1.0 | 0.0542 | 0.2943 | 0.6973 | 1.3788 | 2.7596 | 7.1054 | 7.2831 |
| 3.0 | 0.054 | 0.2197 | 0.5435 | 1.1916 | 2.4955 | 6.8867 | 8.7574 |
| 5.0 | 0.0611 | 0.2777 | 0.6473 | 1.2945 | 2.5423 | 6.7066 | 10.3377 |

TABLE 4
MD Tensile Strength of Polypropylene Fibers and Blended
Polyproplene Fibers As a Function of Elongation (lb/oz)

| EPDM | 1% | 3% | 5% | 10% | 20% | 50% | 100% |
|---|---|---|---|---|---|---|---|
| (%) | Elongation | Elongation | Elongation | Elongation | Elongation | Elongation | Elongation |
| 0.0 | 0.3794 | 1.6074 | 2.3712 | 3.8674 | 6.5002 | 11.2802 | 6.3924 |
| 1.0 | 0.2184 | 1.528 | 2.4407 | 4.134 | 7.0292 | 13.2559 | 7.3538 |
| 3.0 | 0.0959 | 0.8212 | 1.8397 | 3.2335 | 5.4818 | 11.2843 | 8.5314 |
| 5.0 | 0.1145 | 0.8881 | 1.95 | 3.3787 | 5.6081 | 11.4179 | 9.1861 |

In addition to the data shown in Table 2, further cup crush energy data, obtained using the same procedure mentioned above with various levels of EPDM and various melt temperatures, is shown in Table 5.

TABLE 5
Cup Crush Energy Data of Polypropylene
Fibers and Blended Polypropylene Fibers

| | | Cup Crush Energy | | |
|---|---|---|---|---|
| | Melt Temp | ave | | |
| EPDM (%) | (° F.) | (g/mm/oz) | std deviation | % change |
| 0.00 (control) | 460 | 2603 | 345.74 | — |
| 0.59 | 446 | 2630 | 191.55 | 1.0% |
| 0.59 | 474 | 2830 | 180.32 | 8.7% |
| 2.00 | 480 | 2451 | 186.45 | −5.9% |
| 2.00 | 460 | 2281 | 283.83 | −12.4% |
| 2.00 | 440 | 2549 | 139.02 | −2.1% |
| 3.41 | 446 | 2007 | 163.59 | −22.9% |
| 3.41 | 474 | 1825 | 283.15 | −29.9% |
| 4.00 | 460 | 2080 | 126.59 | −20.1% |
| 2.00 | 460 | 1927 | 237.93 | −26.0% |

In addition to the data shown in Table 2, further cup crush load data, obtained using the same procedure mentioned above with various levels of EPDM and various melt temperatures, is shown in Table 6.

TABLE 6
Cup Crush Load Data of Polypropylene
Fibers and Blended Polypropylene Fibers

| | Melt Temp | Cup Crush Load | | |
|---|---|---|---|---|
| EPDM (%) | (° F.) | ave (g/oz) | std deviation | % change |
| 0.00 (control) | 460 | 149 | 19.09 | — |
| 0.59 | 446 | 138 | 9.41 | −7.6% |
| 0.59 | 474 | 146 | 7.98 | −1.9% |
| 2.00 | 480 | 133 | 12.91 | −10.5% |
| 2.00 | 460 | 122 | 15.53 | −18.3% |
| 2.00 | 440 | 134 | 9.20 | −10.3% |
| 3.41 | 446 | 112 | 7.86 | −24.7% |
| 3.41 | 474 | 104 | 14.95 | −30.0% |
| 4.00 | 460 | 115 | 13.25 | −22.6% |
| 2.00 | 460 | 104 | 11.88 | −30.1% |

In addition to the data shown in Table 2, further Elmendorf tear data, obtained using the same procedure mentioned above with various levels of EPDM and various melt temperatures, is shown in Table 7 (MD) and in Table 8 (CD).

TABLE 7
MD Elmendorf Tear Data of Polypropylene
Fibers and Blended Polypropylene Fibers

| | Melt Temp | Elmendorf Tear (MD) | | |
|---|---|---|---|---|
| EPDM (%) | (° F.) | ave (cN/oz) | std deviation | % change |
| 0.00 (control) | 460 | 633 | 146.45 | — |
| 0.59 | 446 | 554 | 76.20 | −12.5% |
| 0.59 | 474 | 532 | 121.58 | −16.0% |
| 2.00 | 480 | 667 | 138.50 | 5.3% |
| 2.00 | 460 | 510 | 101.36 | −19.4% |
| 2.00 | 440 | 570 | 131.78 | −10.0% |
| 3.41 | 446 | 628 | 49.34 | −0.7% |
| 3.41 | 474 | 712 | 115.28 | 12.5% |
| 4.00 | 460 | 654 | 83.00 | 3.3% |
| 2.00 | 460 | 519 | 110.93 | −18.1% |

TABLE 8
CD Elmendorf Tear Data of Polypropylene
Fibers and Blended Polypropylene Fibers

| | Melt Temp | Elmendorf Tear (CD) | | |
|---|---|---|---|---|
| EPDM (%) | (° F.) | ave (cN/oz) | std deviation | % change |
| 0.00 (control) | 460 | 743 | 219.34 | — |
| 0.59 | 446 | 696 | 191.64 | −6.3% |
| 0.59 | 474 | 589 | 73.28 | −20.8% |
| 2.00 | 480 | 557 | 95.33 | −25.1% |
| 2.00 | 460 | 734 | 262.82 | −1.2% |
| 2.00 | 440 | 691 | 245.94 | −7.0% |
| 3.41 | 446 | 728 | 238.83 | −2.1% |
| 3.41 | 474 | 782 | | 5.2% |
| 4.00 | 460 | 662 | 244.59 | −11.0% |
| 2.00 | 460 | 624 | 166.05 | −16.0% |

In addition to the data shown in Table 2, further trap tear data, obtained using the same procedure mentioned above with various levels of EPDM and various melt temperatures, is shown in Table 9 (CD) and in Table 10 (MD).

TABLE 9
CD Trap Tear Data of Polypropylene
Fibers and Blended Polypropylene Fibers

| | Melt Temp | Trap Tear (CD) | | |
|---|---|---|---|---|
| EPDM (%) | (° F.) | ave (lb/oz) | std deviation | % change |
| 0.00 (control) | 460 | 4.88 | 0.36 | — |
| 0.59 | 446 | 5.13 | 0.33 | 5.2% |
| 0.59 | 474 | 4.52 | 0.61 | −7.3% |
| 2.00 | 480 | 4.80 | 0.52 | −1.7% |
| 2.00 | 460 | 4.59 | 0.44 | −6.0% |
| 2.00 | 440 | 5.74 | 0.75 | 17.6% |
| 3.41 | 446 | 5.24 | 0.41 | 7.4% |
| 3.41 | 474 | 5.20 | 0.60 | 6.5% |
| 4.00 | 460 | 5.02 | 0.38 | 3.0% |
| 2.00 | 460 | 4.22 | 0.46 | −13.4% |

TABLE 10
MD Trap Tear Data of Polypropylene
Fibers and Blended Polypropylene Fibers

| | Melt Temp | Trap Tear (MD) | | |
|---|---|---|---|---|
| EPDM (%) | (° F.) | ave (lb/oz) | std deviation | % change |
| 0.00 (control) | 460 | 6.98 | 0.36 | — |
| 0.59 | 446 | 6.75 | 0.68 | −3.4% |
| 0.59 | 474 | 7.41 | 0.79 | 6.1% |
| 2.00 | 480 | 7.99 | 0.74 | 14.5% |
| 2.00 | 460 | 7.96 | 1.01 | 14.0% |
| 2.00 | 440 | 8.64 | 0.87 | 23.7% |
| 3.41 | 446 | 8.78 | 0.92 | 25.7% |
| 3.41 | 474 | 7.44 | 1.22 | 6.6% |
| 4.00 | 460 | 8.31 | 1.46 | 19.0% |
| 2.00 | 460 | 7.18 | 0.69 | 2.9% |

In addition to the data shown in Table 2, further grab load data, obtained using the same procedure mentioned above with various levels of EPDM and various melt temperatures, is shown in Table 11 (CD) and in Table 12 (MD).

TABLE 11
CD Grab Load Data of Polypropylene
Fibers and Blended Polypropylene Fibers

| | Melt Temp | Grab Load (CD) | | |
|---|---|---|---|---|
| EPDM (%) | (° F.) | ave (lb/oz) | std deviation | % change |
| 0.00 (control) | 460 | 11.35 | 0.67 | — |
| 0.59 | 446 | 10.70 | 0.45 | −5.8% |
| 0.59 | 474 | 10.52 | 0.62 | −7.3% |
| 2.00 | 480 | 10.61 | 1.09 | −6.5% |
| 2.00 | 460 | 10.49 | 1.02 | −7.6% |
| 2.00 | 440 | 11.68 | 0.72 | 2.9% |
| 3.41 | 446 | 11.39 | 0.87 | 0.3% |
| 3.41 | 474 | 10.63 | 1.54 | −6.4% |
| 4.00 | 460 | 11.23 | 0.61 | −1.1% |
| 2.00 | 460 | 10.40 | 0.69 | −8.4% |

TABLE 12
MD Grab Load Data of Polypropylene
Fibers and Blended Polypropylene Fibers

| | Melt Temp | Grab Load (MD) | | |
|---|---|---|---|---|
| EPDM (%) | (° F.) | ave (lb/oz) | std deviation | % change |
| 0.00 (control) | 460 | 17.58 | 0.93 | — |
| 0.59 | 446 | 15.76 | 0.97 | −10.3% |
| 0.59 | 474 | 16.69 | 1.21 | −5.1% |
| 2.00 | 480 | 17.67 | 1.32 | 0.5% |
| 2.00 | 460 | 17.28 | 1.56 | −1.7% |
| 2.00 | 440 | 17.71 | 1.08 | 0.8% |
| 3.41 | 446 | 17.35 | 0.93 | −1.3% |
| 3.41 | 474 | 16.81 | 1.27 | −4.4% |
| 4.00 | 460 | 16.76 | 1.17 | −4.7% |
| 2.00 | 460 | 15.17 | 1.58 | −13.7% |

In addition to the data shown in Table 2, further grab strain data, obtained using the same procedure mentioned above with various levels of EPDM and various melt temperatures, is shown in Table 13 (CD) and in Table 14 (MD).

TABLE 13
CD Grab Strain Data of Polypropylene
Fibers and Blended Polypropylene Fibers

| | Melt Temp | Grab Strain (CD) | | |
|---|---|---|---|---|
| EPDM (%) | (° F.) | ave (%) | std deviation | % change |
| 0.00 (control) | 460 | 73.4 | 7.77 | — |
| 0.59 | 446 | 79.1 | 7.40 | 7.7% |
| 0.59 | 474 | 74.3 | 7.82 | 1.3% |
| 2.00 | 480 | 82.7 | 9.21 | 12.6% |
| 2.00 | 460 | 79.3 | 8.15 | 8.0% |
| 2.00 | 440 | 89.0 | 10.08 | 21.2% |
| 3.41 | 446 | 102.4 | 10.83 | 39.5% |
| 3.41 | 474 | 94.3 | 12.44 | 28.4% |
| 4.00 | 460 | 96.7 | 8.53 | 31.8% |
| 2.00 | 460 | 95.3 | 9.39 | 29.8% |

TABLE 14
MD Grab Strain Data of Polypropylene
Fibers and Blended Polypropylene Fibers

| | Melt Temp | Grab Strain (MD) | | |
|---|---|---|---|---|
| EPDM (%) | (° F.) | ave (%) | std deviation | % change |
| 0.00 (control) | 460 | 55.57 | 3.87 | — |
| 0.59 | 446 | 54.68 | 4.42 | −1.6% |
| 0.59 | 474 | 50.38 | 6.48 | −9.3% |
| 2.00 | 480 | 57.10 | 5.35 | 2.8% |
| 2.00 | 460 | 58.21 | 3.29 | 4.8% |
| 2.00 | 440 | 61.06 | 5.40 | 9.9% |
| 3.41 | 446 | 66.51 | 7.09 | 19.7% |
| 3.41 | 474 | 66.37 | 6.33 | 19.4% |
| 4.00 | 460 | 61.26 | 3.04 | 10.2% |
| 2.00 | 460 | 58.83 | 3.60 | 5.9% |

In addition to the data shown in Table 2, further grab energy data, obtained using the same procedure mentioned above with various levels of EPDM and various melt temperatures, is shown in Table 15 (CD) and in Table 16 (MD).

TABLE 15
CD Grab Energy Data of Polypropylene Fibers and Blended
Polypropylene Fibers

| | Melt Temp | Grab Energy (CD) | | |
|---|---|---|---|---|
| EPDM (%) | (° F.) | ave (in-lb/oz) | std deviation | % change |
| 0.00 | 460 | 14.67 | 2.19 | — |
| (control) | | | | |
| 0.59 | 446 | 14.58 | 2.33 | −0.6% |
| 0.59 | 474 | 13.87 | 2.13 | −5.4% |
| 2.00 | 480 | 15.20 | 2.88 | 3.6% |
| 2.00 | 460 | 14.11 | 3.13 | −3.8% |
| 2.00 | 440 | 17.98 | 3.54 | 22.5% |
| 3.41 | 446 | 20.38 | 3.87 | 38.9% |
| 3.41 | 474 | 17.19 | 4.81 | 17.2% |
| 4.00 | 460 | 18.30 | 2.04 | 24.8% |
| 2.00 | 460 | 17.04 | 3.15 | 16.2% |

TABLE 16
MD Grab Energy Data of Polypropylene Fibers and Blended
Polypropylene Fibers

| | Melt Temp | Grab Energy (MD) | | |
|---|---|---|---|---|
| EPDM (%) | (° F.) | ave (in-lb/oz) | std deviation | % change |
| 0.00 | 460 | 18.46 | 1.99 | — |
| (control) | | | | |
| 0.59 | 446 | 16.08 | 1.93 | −12.9% |
| 0.59 | 474 | 16.04 | 3.24 | −13.1% |
| 2.00 | 480 | 18.97 | 2.54 | 2.8% |
| 2.00 | 460 | 18.76 | 1.40 | 1.6% |
| 2.00 | 440 | 20.40 | 2.82 | 10.5% |
| 3.41 | 446 | 21.03 | 3.03 | 13.9% |
| 3.41 | 474 | 20.31 | 3.25 | 10.0% |
| 4.00 | 460 | 18.89 | 2.09 | 2.3% |
| 2.00 | 460 | 16.36 | 2.49 | −11.4% |

In addition to the data shown in Table 2, further denier data, obtained using the same procedure mentioned above with various levels of EPDM and various melt temperatures, is shown in Table 17.

TABLE 17
Denier Data of Polypropylene Fibers and Blended Polypropylene
Fibers

| | Melt Temp | | | |
|---|---|---|---|---|
| EPDM (%) | (° F.) | average | std deviation | % change |
| 0.00 | 460 | 2.67 | 0.40 | — |
| (control) | | | | |
| 0.59 | 446 | 2.85 | 0.25 | 6.7% |
| 0.59 | 474 | 2.66 | 0.28 | −0.5% |
| 2.00 | 480 | 2.60 | 0.39 | −2.5% |
| 2.00 | 460 | 2.44 | 0.18 | −8.4% |
| 2.00 | 440 | 2.65 | 0.22 | −0.7% |
| 3.41 | 446 | 2.61 | 0.22 | −2.3% |
| 3.41 | 474 | 2.79 | 0.51 | 4.4% |
| 4.00 | 460 | 2.41 | 0.22 | −9.9% |
| 2.00 | 460 | 2.30 | 0.21 | −13.8% |

The processability of this particular blend is quite good relative to other copolymer/polypropylene blends previously tested, due to a lack of melt elasticity in the EPDM/PP fibers. The presence of melt elasticity leads to a phenomena commonly referred to as “roping” wherein fiber breaks below the pack snap back toward the pack, thereby entangling additional fibers. The lack of “roping” allows these EPDM/PP fibers to be processed in existing equipment. The EPDM/PP fibers achieve a plasticizing effect that allows the polypropylene chains to slip more easily. The result is a more highly aligned structure that hinders the kinetic driving force toward chain entanglement at the molecular level.

Additional stabilized textile fibers were prepared from Escorene 3155 polypropylene, and from a combination of KRATON® 2760 blended with Escorene 3155 polypropylene. The KRATON® 2760 and polypropylene were combined using the preferred process described above with respect to FIG. 1. Both the polypropylene fibers and the blended fibers were successfully drawn between 0.4 grams/hole/minute and 0.6 grams/hole/minute at a range of temperature from 230 degrees Celsius to 250 degrees Celsius, although there is no apparent restriction on throughput or temperature for the fibers of the invention. The drawing pressure used in the fiber drawing unit allowed fibers to be drawn at pressures up to and above 15 psi. Other specifics include the use of a 310 hole pack at 128 holes/inch with hole diameters of 0.6 mm. Each of the fibers were tested for tear strength, peak load, energy, and strain, according to the procedures referenced above. The compositions of the fibers tested are shown in Table 18. The data extracted from these tests is shown in Table 19.

TABLE 18
Composition of Polypropylene Fibers and Blended Polypropylene
Fibers Tested

| | | Bond Temp | Basis Weight |
|---|---|---|---|
| Sample | Composition | (° F.) | (oz/yd²) |
| 1a | 100% PP | 285 | 0.479 |
| 2a | 99% PP/1% KRATON ® 2760 | 284 | 0.469 |
| 3a | 98% PP/2% KRATON ® 2760 | 284 | 0.449 |
| 1b | 100% PP | 303 | 0.504 |
| 2b | 99% PP/1% KRATON ® 2760 | 296 | 0.483 |
| 3b | 98% PP/2% KRATON ® 2760 | 302 | 0.442 |
| 1c | 100% PP | 280 | 1.029 |
| 2c | 99% PP/1% KRATON ® 2760 | 284 | 0.987 |
| 3c | 98% PP/2% KRATON ® 2760 | 280 | 0.911 |
| 1d | 100% PP | 300 | 1.047 |
| 2d | 99% PP/1% KRATON ® 2760 | 296 | 1.014 |
| 3d | 98% PP/2% KRATON ® 2760 | 300 | 0.978 |

TABLE 19
Polypropylene Fibers Versus Polypropylene Fibers Blended With
KRATON ® 2760

| | | | Peak | Peak | | | | |
|---|---|---|---|---|---|---|---|---|
| | Tear | Tear | Load | Load | | Energy | | |
| | CD | MD | CD | MD | Energy | MD | Strain | Strain |
| | (lb/ | (lb/ | (lb/ | (lb/ | CD (in- | (in- | CD | MD |
| Sample | oz) | oz) | oz) | oz) | lb/oz) | lb/oz) | (%) | (%) |
| 1a | 849.5 | 1003 | 3.9 | 8.39 | 3.20 | 7.89 | 3.90 | 78.97 |
| 2a | 1317.2 | 1332 | 2.48 | 6.33 | 1.02 | 3.11 | 2.48 | 50.96 |
| 3a | 779.8 | 890 | 3.97 | 7.17 | 3.36 | 6.09 | 3.97 | 81.29 |
| 1b | 440.7 | 701 | 4.86 | 10.14 | 4.43 | 9.51 | 4.86 | 79.29 |
| 2b | 469.5 | 817 | 5.83 | 9.76 | 5.24 | 8.90 | 5.43 | 84.91 |
| 3b | 401.2 | 469 | 4.59 | 7.09 | 3.54 | 4.42 | 4.59 | 59.96 |
| 1c | 543.9 | 848 | 3.68 | 7.65 | 2.36 | 4.90 | 3.68 | 31.62 |
| 2c | 1021.8 | 1135 | 3.85 | 6.10 | 2.77 | 3.02 | 3.85 | 29.04 |
| 3c | 520.8 | 600 | 5.63 | 8.88 | 6.23 | 10.73 | 5.63 | 58.11 |
| 1d | 538.6 | 642 | 5.75 | 9.65 | 6.60 | 9.19 | 5.75 | 43.64 |
| 2d | 633.4 | 827 | 5.66 | 10.57 | 5.97 | 10.36 | 5.66 | 44.48 |
| 3d | 341.9 | 542 | 6.14 | 8.56 | 7.30 | 9.97 | 6.14 | 54.38 |

In addition to the data shown in Table 19, Elmendorf tear data, obtained using the same procedure mentioned above with various levels of KRATON® 2760 and various bond temperatures, is shown in Table 20.

TABLE 20
Elmendorf Tear Data of Polypropylene Fibers and Blended
Polypropylene Fibers

| | | Elmendorf Tear | | | |
|---|---|---|---|---|---|
| KRATON ® | Bond Temp | CD ave | std | MD ave | std |
| 2760 (%) | (° F.) | (cN/oz) | deviation | (cN/oz) | deviation |
| 0.0 | 302 | 320 | 56.629 | 692.8 | 58.62 |
| 0.74 | 315 | 287.6 | 48.7 | 401 | 27.6 |
| 0.74 | 304 | 440.2 | 75.75 | 721 | 80.98 |
| 0.74 | 283 | 509.9 | 74.44 | 739.1 | 37.1 |
| 1.11 | 307 | 336.4 | 40.66 | 521.4 | 30.21 |
| 1.11 | 293 | 393.5 | 38.88 | 600.3 | 133.19 |
| 1.11 | 281 | 445.2 | 55.33 | 741.1 | 23.5 |
| 1.48 | 283 | 352.7 | 57.28 | 654.5 | 110.6 |

In addition to the data shown in Table 19, Grab tensile data, obtained using the same procedures mentioned above with various levels of KRATON® 2760 and various bond temperatures, is shown in Table 21 (MD) and in Table 22 (CD).

TABLE 21
MD Grab Tensile Data of Polypropylene Fibers and Blended
Polypropylene Fibers

| | | | | MD | | MD | |
|---|---|---|---|---|---|---|---|
| | | MD Peak Load | | Peak Strain | | Peak Energy | |
| | Bond | ave | std | | std | ave | std |
| KRATON ® | Temp | (lb/ | devia- | ave | devia- | (in- | devia- |
| 2760 (%) | (° F.) | oz) | tion | (%) | tion | lb/oz) | tion |
| 0 | 302 | 19.44 | 1.44 | 46.78 | 4.84 | 16.75 | 2.89 |
| 10 | 315 | 19.17 | 2.16 | 42.52 | 5.88 | 15.3 | 3.52 |
| 10 | 304 | 21.47 | 2.17 | 53.2 | 5.89 | 20.82 | 3.99 |
| 10 | 283 | 17.63 | 0.98 | 46.4 | 2.62 | 14.46 | 1.43 |
| 15 | 307 | 20.41 | 1.92 | 46.67 | 4.5 | 17.44 | 2.99 |
| 15 | 293 | 19.76 | 1.63 | 47.77 | 3.77 | 17.03 | 2.71 |
| 15 | 281 | 18.65 | 1.08 | 48.55 | 3.83 | 16.31 | 2.09 |
| 20 | 283 | 20.23 | 0.92 | 53.04 | 3.68 | 19.14 | 2.18 |

TABLE 22
CD Grab Tensile Data of Polypropylene Fibers and Blended
Polypropylene Fibers

| | | | | CD | | CD | |
|---|---|---|---|---|---|---|---|
| | | CD Peak Load | | Peak Strain | | Peak Energy | |
| | Bond | ave | std | | std | ave | std |
| KRATON ® | Temp | (lb/ | devia- | ave | devia- | (in- | devia- |
| 2760 (%) | (° F.) | oz) | tion | (%) | tion | lb/oz) | tion |
| 0 | 302 | 14.74 | 2.17 | 58.2 | 11.61 | 14.46 | 4.58 |
| 10 | 315 | 16.04 | 1.96 | 58.37 | 9.54 | 15.97 | 4.6 |
| 10 | 304 | 16.85 | 1.22 | 62.9 | 3.88 | 17.67 | 2.13 |
| 10 | 283 | 14.01 | 0.89 | 60.88 | 5.51 | 14.19 | 2.14 |
| 15 | 307 | 17.1 | 1.75 | 69.78 | 7.18 | 20.31 | 4.22 |
| 15 | 293 | 15.46 | 1.64 | 62.15 | 8.32 | 16.1 | 4.04 |
| 15 | 281 | 14.33 | 1.12 | 62.98 | 5.7 | 15.19 | 2.31 |
| 20 | 283 | 14.19 | 2.39 | 63.24 | 9.83 | 15.18 | 4.46 |

In addition to the data shown in Table 19, grab tensile data, obtained using the procedure in ASTM D5034-95 with various levels of KRATON® 2760 and various bond temperatures, is shown in Table 23 (MD) and in Table 24 (CD).

TABLE 23
MD Grab Tensile Data of Polypropylene Fibers and Blended
Polypropylene Fibers

| | | | | MD | | MD | |
|---|---|---|---|---|---|---|---|
| | | MD Peak Load | | Peak Strain | | Peak Energy | |
| | Bond | ave | std | | std | ave | std |
| KRATON ® | Temp | (lb/ | devia- | ave | devia- | (in- | devia- |
| 2760 (%) | (° F.) | oz) | tion | (%) | tion | lb/oz) | tion |
| 0 | 302 | 8.1 | 0.49 | 54.56 | 6.01 | 9.27 | 1.38 |
| 10 | 315 | 8.11 | 0.89 | 48.97 | 10.77 | 8.55 | 2.78 |
| 10 | 304 | 8.33 | 0.48 | 65.85 | 7.88 | 11.69 | 2.01 |
| 10 | 283 | 7.99 | 0.37 | 55.82 | 4.37 | 9.18 | 1.14 |
| 15 | 307 | 8.4 | 0.73 | 50.9 | 4.37 | 8.96 | 1.46 |
| 15 | 293 | 8.92 | 0.6 | 61.83 | 5.43 | 11.44 | 1.57 |
| 15 | 281 | 8.27 | 0.36 | 59.88 | 5.01 | 10.23 | 1.45 |
| 20 | 283 | 8.19 | 0.67 | 64.07 | 9.32 | 11.08 | 2.23 |

TABLE 24
CD Grab Tensile Data of Polypropylene Fibers and Blended
Polypropylene Fibers

| | | | | CD | | CD | |
|---|---|---|---|---|---|---|---|
| | | CD Peak Load | | Peak Strain | | Peak Energy | |
| | Bond | ave | std | | std | ave | std |
| KRATON ® | Temp | (lb/ | devia- | ave | devia- | (in- | devia- |
| 2760 (%) | (° F.) | oz) | tion | (%) | tion | lb/oz) | tion |
| 0 | 302 | 4.94 | 0.63 | 57.25 | 13.48 | 5.59 | 2.08 |
| 10 | 315 | 5.1 | 0.73 | 52.55 | 8.47 | 5.26 | 1.73 |
| 10 | 304 | 5.68 | 0.55 | 65.76 | 8.85 | 7.24 | 1.65 |
| 10 | 283 | 4.66 | 0.37 | 57.29 | 7 | 5.15 | 1.06 |
| 15 | 307 | 5.13 | 0.76 | 51.94 | 9.4 | 5.3 | 1.66 |
| 15 | 293 | 4.89 | 0.83 | 61.29 | 9.59 | 5.82 | 1.75 |
| 15 | 281 | 4.54 | 0.49 | 54.93 | 8.29 | 4.81 | 1.16 |
| 20 | 283 | 4.95 | 0.72 | 61.08 | 7.6 | 5.9 | 1.55 |

The textile fibers of the invention can be incorporated into disposable absorbent articles. Examples of such suitable articles include diapers, training pants, feminine hygiene products, incontinence products, other personal care or health care garments, including medical garments, or the like.

### Cup Crush Test Method

The cup crush test is used to measure the softness of a material by using the peak load and energy units from a constant-rate-of-extension tensile testing machine. The lower the peak load value, the softer the material.

This test procedure was conducted in a controlled environment wherein the temperature was about 73° F. and the relative humidity was about 50%. Samples were tested using a Sintech System 2 Computer Integrated Testing System available from Sintech Corp., having offices in Cary, N.C., and a Cup Crush Test Stand available from Kimberly-Clark Corporation Quality Assurance Department in Neenah, Wis., which included a model 11 foot, a model 31 steel ring, a base plate, a model 41 cup assembly, and a calibration set.

The steel ring was placed over the forming cylinder and a 9-inch by 9-inch (22.9-cm by 22.9-cm) sample was centered over the forming cylinder. The forming cup was slid over the forming cylinder until the sample was pinched between the forming cylinder and the steel ring all the way around the steel ring. The forming cup was placed on top of the base plate of the load cell and firmly seated over the ridge of the base plate. The foot was mechanically lowered into the forming cup with the crosshead speed set at 400 millimeters/minute, crushing the sample while the constant-rate-of-extension tensile testing machine measured the peak load in grams and the energy in gram-mm needed to crush the sample.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

We claim:

1. A textile fiber comprising polypropylene blended with about 1-25% by weight impact modifier.

2. The textile fiber of claim 1, wherein the textile fiber comprises about 2-15% by weight impact modifier.

3. The textile fiber of claim 1, wherein the textile fiber comprises about 3-10% by weight impact modifier.

4. The textile fiber of claim 1, wherein the impact modifier comprises a copolymer selected from the group consisting of ethylene-propylene-diene-monomer, styrene/ethylene-co-butadiene/styrene, and styrene-poly(ethylene-propylene)-styrene-poly(ethylene-propylene).

5. A spunbond fiber comprising the textile fiber of claim 1.

6. A staple fiber comprising the textile fiber of claim 1.

7. A multi-fiber yarn comprising the textile fiber of claim 1.

8. A knit fabric comprising the textile fiber of claim 1.

9. A woven fabric comprising the textile fiber of claim 1.

10. A nonwoven fabric comprising the textile fiber of claim 1.

11. An absorbent article comprising the nonwoven fabric of claim 10.

12. A textile fiber comprising polypropylene blended with about 2-15% by weight impact modifier, the impact modifier selected from the group consisting of ethylene-propylene-diene-monomer, styrene/ethylene-co-butadiene/styrene, and styrene-poly(ethylene-propylene)-styrene-poly(ethylene-propylene).

13. A spunbond fiber comprising the textile fiber of claim 12.

14. A staple fiber comprising the textile fiber of claim 12.

15. A multi-fiber yarn comprising the textile fiber of claim 12.

16. A knit fabric comprising the textile fiber of claim 12.

17. A woven fabric comprising the textile fiber of claim 12.

18. A nonwoven fabric comprising the textile fiber of claim 12.

19. An absorbent article comprising the nonwoven fabric of claim 18.

20. A nonwoven fabric comprising a plurality of modified fibers, the modified fibers including polypropylene blended with about 1-25% by weight impact modifier, the impact modifier selected from the group consisting of ethylene-propylene-diene-monomer, styrene/ethylene-co-butadiene/styrene, and styrene-poly(ethylene-propylene)-styrene-poly(ethylene-propylene).

21. The nonwoven fabric of claim 20, wherein the modified fibers comprise about 2-15% by weight impact modifier.

22. The nonwoven fabric of claim 20, wherein the modified fibers comprise about 3-10% by weight impact modifier.

23. An absorbent article comprising the nonwoven fabric of claim 20.
